(19) United States
(12) Patent Application Publication
(10) Pub. No.: US 2025/0080506 A1
(43) Pub. Date: Mar. 6, 2025

(54) METHODS AND SYSTEMS OF FACILITATING SECURE COMMUNICATION

(71) Applicants: Todd Marlin, Park City, UT (US); Marisa Marlin, City, UT (US)

(72) Inventors: Todd Marlin, Park City, UT (US); Marisa Marlin, City, UT (US)

(21) Appl. No.: 18/821,767

(22) Filed: Aug. 30, 2024

Related U.S. Application Data
(60) Provisional application No. 63/579,758, filed on Aug. 30, 2023.

(51) Int. Cl. H04L 9/40

(52) U.S. Cl. CPC H04L 63/0421; H04L 63/0428

(57) ABSTRACT

The present disclosure provides a method of facilitating secure communication. Further, the method may include receiving, using a communication device, a first data from a first user device. Further, the method may include analyzing, using a processing device, the first data based on a rule data. Further, the method may include generating, using the processing device, a manipulated data based on the analyzing. Further, the method may include transmitting, using the communication device, the manipulated data to a second user device.

### REFERENCE TO RELATED APPLICATIONS

This application claims the benefit of U.S. Provisional Patent Application No. 63/579,758, titled “METHODS AND SYSTEMS FOR FACILITATING DATA SECURITY DURING ONLINE INFORMATION STREAM COLLABORATION”, filed Aug. 30, 2023, which is incorporated by reference herein in its entirety.

### FIELD OF THE INVENTION

The present disclosure generally relates to the field of data processing. More specifically, the present disclosure relates to methods and systems of facilitating secure communication.

### BACKGROUND OF THE INVENTION

The field of data processing is technologically important to several industries, business organizations, and/or individuals. Existing techniques of facilitating secure communication are deficient in several ways.

In the existing communication technologies, there are several instances wherein the data is redundantly received, transmitted, and processed. Therefore, there is a huge waste of computational resources. In the existing communication technologies, the data consumes a lot of memory, network bandwidth, and power for storage. In the existing communication technologies, a huge amount of heat is generated by the devices leading to a requirement of a huge amount of cooling to keep the devices operational. The existing communication technologies require a large amount of processing time. The existing communication technologies may not have the process of data modification facilitating user anonymity. The existing communication technology may not include modification of audio data resulting in non-identification of the user. However, the existing communication technologies face several limitations, which may include, compatibility with all video conferencing products, selectively or fully blocking applications in session, real-time face blurring, and integration via local or wide area networks.

Therefore, there is a need for improved methods and systems of facilitating secure communication that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present disclosure provides a method of facilitating secure communication. Further, the method may include receiving, using a communication device, a first data from a first user device. Further, the method may include analyzing, using a processing device, the first data based on a rule data. Further, the method may include generating, using the processing device, a manipulated data based on the analyzing. Further, the method may include transmitting, using the communication device, the manipulated data to a second user device.

The present disclosure provides a system for facilitating secure communication. Further, the system may include a communication device. Further, the communication device may be configured for receiving a first data from a first user device. Further, the communication device may be configured for transmitting the first data to a second user device based on an analyzing. Further, the system may include a processing device which may be configured for analyzing the first data based on a rule data.

The present disclosure provides a method of facilitating secure communication. Further, the method may include receiving, using a communication device, a first data from a first user device. Further, the method may include analyzing, using a processing device, the first data based on a rule data. Further, the method may include transmitting, using the communication device, the first data to a second user device based on the analyzing.

The present disclosure provides a method of facilitating secure communication. Further, the method may include receiving, using a communication device, a first data from a first user device. Further, the method may include receiving, using the communication device, a rule data from the first user device. Further, the method may include analyzing, using a processing device, the first data based on the rule data. Further, the method may include generating, using the processing device, a manipulated data based on the analyzing. Further, the method may include transmitting, using the communication device, the manipulated data to a second user device.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTIONS OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform 100 consistent with various embodiments of the present disclosure.

FIG. 2 is a block diagram of a computing device 200 for implementing the methods disclosed herein, in accordance with some embodiments.

FIG. 3 illustrates a flowchart of a method 300 of facilitating secure communication, in accordance with some embodiments.

FIG. 4 illustrates a flowchart of a method 400 of facilitating secure communication including generating, using the processing device 504, an alert data, in accordance with some embodiments.

FIG. 5 illustrates a block diagram of a system 500 of facilitating secure communication, in accordance with some embodiments.

FIG. 6 illustrates a flowchart of a method 600 of facilitating secure communication, in accordance with some embodiments.

FIG. 7 illustrates a flowchart of a method 700 of facilitating secure communication, in accordance with some embodiments.

FIG. 8 illustrates a flowchart of a method 800 of facilitating secure communication including generating an alert data, in accordance with some embodiments.

FIG. 9 is a flowchart of a method 900 for facilitating data security during online information stream collaboration, in accordance with some embodiments.

FIG. 10 is a flowchart of a method 1000 for facilitating data security during online information stream collaboration, in accordance with some embodiments.

FIG. 11 is a block diagram of a system 1100 for facilitating data security during online information stream collaboration, in accordance with some embodiments.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of the disclosed use cases, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g., a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g., Windows, Mac OS, Unix, Linux, Android, etc.) in order to provide a user interface (e.g., GUI, touch-screen based interface, voice based interface, gesture based interface, etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g., username, password, passphrase, PIN, secret question, secret answer, etc.) and/or possession of a machine readable secret data (e.g., encryption key, decryption key, bar codes, etc.) and/or or possession of one or more embodied characteristics unique to the user (e.g., biometric variables such as, but not limited to, fingerprint, palm-print, voice characteristics, behavioral characteristics, facial features, iris pattern, heart rate variability, evoked potentials, brain waves, and so on) and/or possession of a unique device (e.g., a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g., transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g., the server computer, a client device, etc.) corresponding to the performance of the one or more steps, environmental variables (e.g., temperature, humidity, pressure, wind speed, lighting, sound, etc.) associated with a device corresponding to the performance of the one or more steps, physical state and/or physiological state and/or psychological state of the user, physical state (e.g., motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g., a real-time clock), a location sensor (e.g., a GPS receiver, a GLONASS receiver, an indoor location sensor, etc.), a biometric sensor (e.g., a fingerprint sensor), an environmental variable sensor (e.g., temperature sensor, humidity sensor, pressure sensor, etc.) and a device state sensor (e.g., a power sensor, a voltage/current sensor, a switch-state sensor, a usage sensor, etc. associated with the device corresponding to performance of the or more steps). Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g., initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview

The present disclosure illustrates a set of advanced tools to allow individuals to share personal, private, and even business critical data with utmost protection. Further, the disclosed system may focus on security and confidentiality of the data that is not visible to the user and is stored in a server outside of the user's control. Further, the disclosed system may help in mitigating privacy risks caused by sharing of a confidential material by a user purposely or inadvertently on screen or via sharing capability. The disclosed system may facilitate data security during online video collaboration. According to the disclosed system, integration of AI during video collaboration sessions may be performed to offer real-time privacy and prevent legal ramifications.

The disclosed system may safeguard from several bad actors made up of nation-states and criminal organizations that have created an industry out of identity theft and stealing corporate secrets, and for them these video platforms gift wrap sensitive information on a silver platter. Further, organizations have an obligation in many jurisdictions, such as the EU, to ensure personal data is protected. Further, in the EU, organizations that utilize online meetings are considered as “controllers”. Further, the “controller” of personal data may have the accountability to ensure that personal data is protected and General Data Protection Regulation requirements respected, even if the processing is being done by a third party. Further, the “controllers” may have the obligation to ensure the protection and privacy of personal data when that data is being transferred outside the organization, to a third party and/or other entity within the same organization. The disclosed system may suggest organizations to ensure that technical controls are in place to protect the confidentiality, integrity, availability, and resilience of any personal data and to compound the risk for multinational businesses on which fines are imposed by reference to the revenues of an undertaking rather than the revenues of the relevant controller or processor.

For instance, violations of certain regulations such as disclosure of personally identifiable information like Social Security Number, Birth Date, Address and Phone number of an individual or a family, may result in identity theft, fraud or loss of assets, safety and discrimination. Further, the disclosure of personally identifiable information which includes, Social Security Number, Birth Date, Address and Phone number of an employer may result in privacy breach and regulatory violations as per General Data Protection Regulation, Central Consumer Protection Authority, Health Insurance Portability and Accountability Act, etc. In an instance, the disclosure of personally identifiable information which includes, Social Security Number, Birth Date, Address and Phone number related to an employee, may result in discrimination in employment or advancement and invasion of privacy.

Similarly, in an instance, disclosure of personal health information of an individual or a family, may result in discrimination and loss of confidentiality. Further, the disclosure of personal health information of an employer may result in privacy breach and regulatory violations. Similarly, in an instance, the disclosure of personal information of an employee, may result in discrimination in employment or advancement and invasion of personal life.

Similarly, in an instance, disclosure of company secrets by an employer, may result in loss of market advantage. Similarly, in an instance, the disclosure of company secrets by an employee, may result in loss of employment and has an impact on future employment.

Similarly, in an instance, disclosure of customer or client information by an employer, may result in loss of customers, market advantage and violation of contracts. Similarly, in an instance, disclosure of customer or client information by an employee, may result in personal liability, loss of employment and impact on future employment.

Similarly, in an instance, disclosure of employee information by an employer, may result in privacy breach and regulatory violations that comply with General Data Protection Regulation, Central Consumer Protection Authority and Health Insurance Portability and Accountability Act. Similarly, in an instance, disclosure of employee information by an employee, may result in identity theft, fraud or loss of assets, safety and discrimination.

Similarly, in an instance, disclosure of emails related to an individual or a family, may result in identity theft, fraud or loss of assets, safety and discrimination. Similarly, in an instance, disclosure of emails related to an employer, may result in privacy breach and regulatory violations that comply with General Data Protection Regulation, Central Consumer Protection Authority and Health Insurance Portability and Accountability Act. Similarly, in an instance, disclosure of emails related to an employee, may result in discrimination in employment or advancement and invasion of personal life.

Similarly, in an instance, disclosure of credit card statements related to an individual or a family, may result in identity theft, fraud or loss of assets, safety and discrimination. Similarly, in an instance, disclosure of credit card statements related to an employer, may result in privacy breach and regulatory violations that comply with General Data Protection Regulation, Central Consumer Protection Authority and Health Insurance Portability and Accountability Act. Similarly, in an instance, disclosure of credit card statements related to an employee, may result in discrimination in employment or advancement and invasion of personal life.

Similarly, in an instance, disclosure of system credentials related to an individual and an employer, may result in data breach. Similarly, in an instance, disclosure of system credentials of a family may result in loss of assets.

The disclosed system may be configured to automatically detect and redact various types of sensitive data during a video collaboration meeting. A real-time face-blur technology may be used to allow complete privacy for individuals joining a video session anonymously. In this system, specific apps may be selectively redacted and/or fully blocked in the session. A privacy layer may be added to block, redact and alert the shared data. The system may be compatible with all video conferencing products, on all devices. This system may provide the user, options to integrate via the cloud or locally. The key features of the disclosed system may include collaboration platform independence, ready-to-go rules, the ability to create custom rules, desktop-driven, alerts, and an account that allows a user to manage their subscription in a single hub. The business companies may use this invention for technical/customer support, collaboration in business meetings and telehealth services. The disclosed system may be used by financial applications, medical and healthcare domain, social media, online communities, online retailers and customer metrics. Therefore, this disclosed system protects personal information, financial account information, confidential legal documents and personal files.

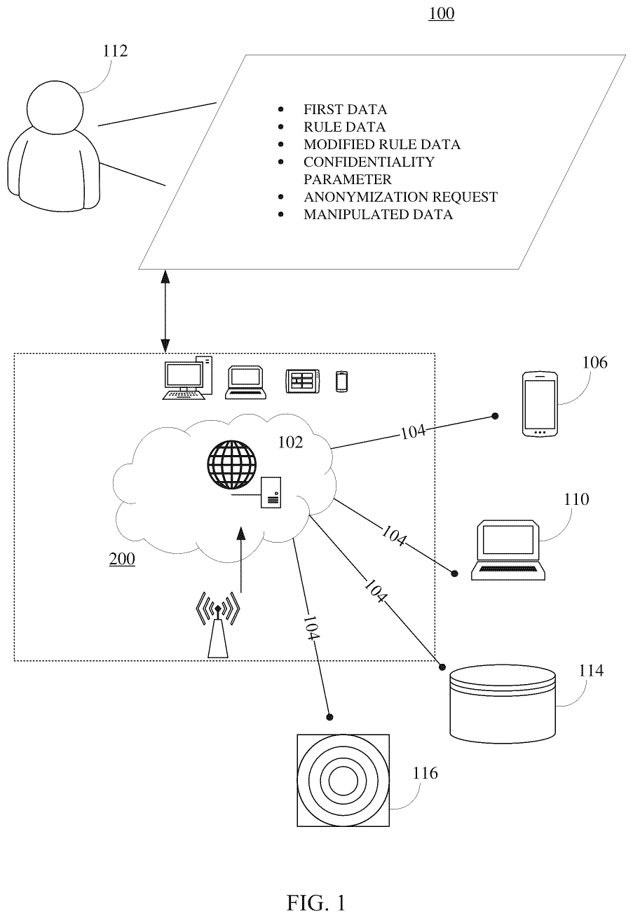

FIG. 1 is an illustration of an online platform 100 consistent with various embodiments of the present disclosure. By way of non-limiting example, the online platform 100 may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, and sensors 116 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 200.

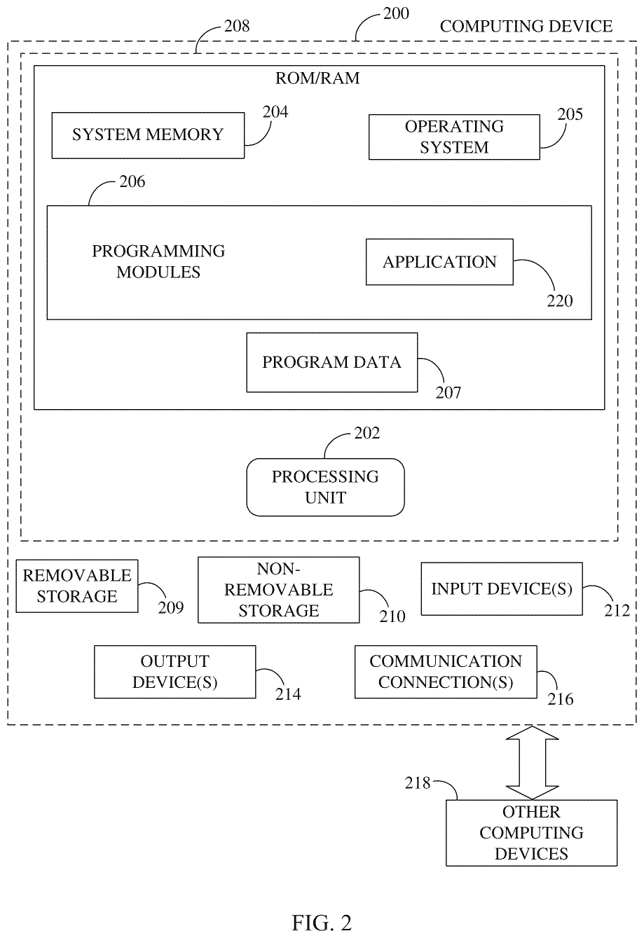

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g., random-access memory (RAM)), non-volatile (e.g., read-only memory (ROM)), flash memory, or any combination. System memory 204 may include operating system 205, one or more programming modules 206, and may include a program data 207. Operating system 205, for example, may be suitable for controlling computing device 200's operation. In one embodiment, programming modules 206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

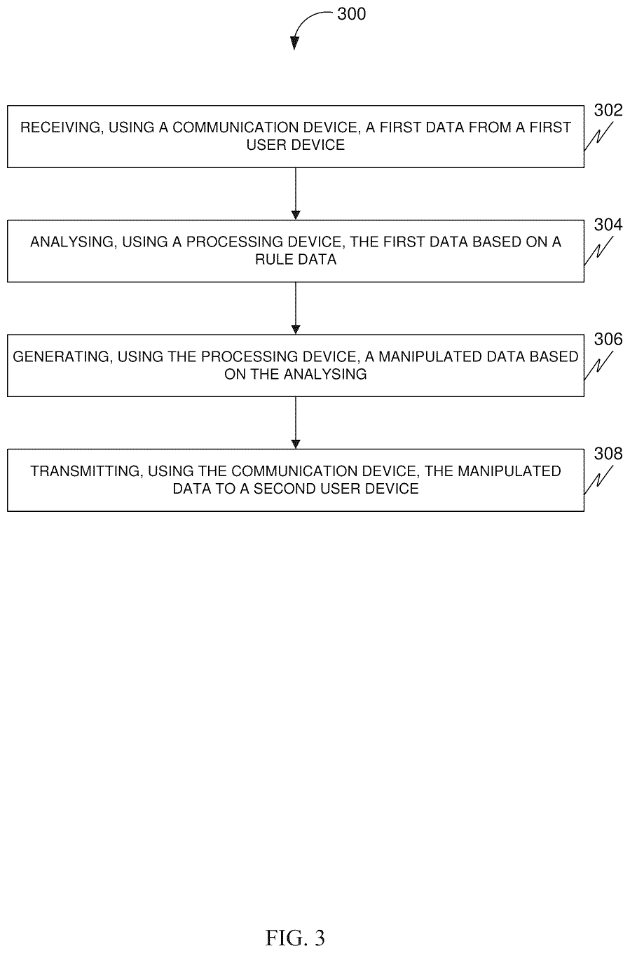

FIG. 3 illustrates a flowchart of a method 300 of facilitating secure communication, in accordance with some embodiments.

Accordingly, the method 300 may include a step 302 of receiving, using a communication device 502, a first data from a first user device. Further, the method 300 may include a step 304 of analyzing, using a processing device 504, the first data based on a rule data. Further, the method 300 may include a step 306 of generating, using the processing device 504, a manipulated data based on the analyzing. Further, the method 300 may include a step 308 of transmitting, using the communication device 502, the manipulated data to a second user device.

Further, in some embodiments, the first data includes one or more communication streams. Further, the one or more communication streams may be received in real time. Further, the one or more communication streams may include data streams for communicating in the online meeting. Further, the one or more communication streams may include a video stream, an audio stream, an audio video stream, etc. Further, the manipulated data includes one or more protected communication streams. Further, the one or more protected communication streams may be generated in real time. Further, the sensitive data, the private data, personal identifiers, etc. may be redacted in the one or more protected communication streams. Further, the analyzing of the first data based on the rule data may include applying a privacy layer on the one or more communication streams. Further, the rule data may include the privacy layer.

Further, in an embodiment, the secure communication may be for an online meeting. Further, the method 300 may include a step of receiving, using a communication device 502, one or more information associated with the online meeting from the first user device associated with a first user. Further, the one or more information may include at least one conference information. Further, the online meeting may include at least one online information stream collaboration. Further, the online meeting may include a virtual meeting, a conferencing, a video conferencing, a telemeeting, a teleconferencing, etc. Further, the online meeting may be a communication session. Further, the communication session may include a virtual communication session, a video communication session, an audio video communication session, an audio communication session, etc. Further, the online meeting may be managed by computing devices, servers, client devices, etc. Further, the computing devices, servers, client devices, etc. may host/comprise at least one platform for managing the online meeting. Further, the at least one platform may include a collaboration platform. Further, the at least one platform may correspond to one or more video conferencing products. Further, the one or more information may include at least one characteristic of the online meeting. Further, the at least one characteristic may include a type of the online meeting, a platform used for the online meeting, a device used for the online meeting, etc. Further, the online meeting allows two or more users in different locations to communicate with each other in almost real time by transmitting and receiving communication streams (such as data). Further, the communication streams may include video, images, animations, audio, text, documents, etc. among two or more user devices of the two or more users. For instance, the two or more users in the online meeting may host an event such as a video chat session, a presentation, an audio chat session, etc., share a document, a picture, an audio, a video, etc. Further, the first user device may include client devices, computing devices, devices, etc. Further, the method 300 may include a step of analyzing, using a processing device 504, the one or more information. Further, the method 300 may include a step of determining, using the processing device 504, the privacy layer for the protecting of the privacy of the one or more users during the online meeting based on the analyzing of the one or more information. Further, the privacy layer may include a privacy level. Further, the privacy layer may correspond to an amount of redacting of the communication streams. Further, the redacting may include blocking, censoring, removing, obfuscating, obscuring, masking, blurring, distorting, encrypting, etc. Further, the applying of the privacy layer on the one or more communication streams may be based on the determining of the privacy layer.

Further, in an embodiment, the analyzing of the first data based on the rule data may include identifying one or more content elements comprised in the one or more communication streams. Further, the one or more content elements may include at least an image and a portion of the image of at least one object, at least an image and a portion of at least one environment (such as a surrounding of the at least one object), an audio (such as a sound, a music, etc.), a speech (such as a word, a sentence, a paragraph, etc.), etc. Further, the applying of the privacy layer on the one or more communication streams may be based on the identifying of the one or more content elements. Further, the applying of the privacy layer includes redacting the one or more content elements comprised in the one or more communication streams. Further, the redacting of the one or more content elements may include redacting at least partially and fully the one or more content elements. Further, the generating of the manipulated data comprising the one or more protected communication streams may be based on the redacting the one or more content elements comprised in the one or more communication streams.

In an embodiment, the analyzing of the one or more information includes analyzing the one or more information using one or more first machine learning models. Further, the one or more first machine learning models determine a privacy risk for the first user participating in the online meeting and rank the privacy risk for the first user. Further, the one or more first machine learning models may include convolutional neural networks, recurrent neural networks, support vector machines, decision tree models, random forest models, etc. Further, the privacy risk may include a probability of a revelation of a sensitive data (such as a sensitive document, a sensitive speech, a sensitive image, etc.) from the one or more communication streams, a revelation of a private data (such as a private image, a private speech (such as an idiosyncratic speech) from the first data comprising the one or more communication streams, a revelation of personal identifiers (such as face, voice, body marks, body parts (such as a torso, etc.), etc.) of the one or more users from the first data comprising the one or more communication streams, etc. Further, the method 300 includes a step of determining, using the processing device 504, a protection level required for the first user for the protecting of the privacy of the first user against the privacy risk based on the analyzing of the one or more information using the one or more first machine learning models. Further, the protection level corresponds to a rank of the privacy risk. Further, the determining of the privacy layer includes selecting the privacy layer from two or more privacy layers based on the protection level. Further, the applying of the privacy layer on the one or more communication streams may be based on the selecting of the privacy layer from the plurality of privacy layers.

Further, in an embodiment, the analyzing of the first data may include analyzing the one or more communication streams using one or more machine learning models. Further, the one or more machine learning models may include convolutional neural networks, recurrent neural networks, support vector machines, decision tree models, random forest models, etc. Further, the one or more machine learning models may be trained using a training data for detecting content elements comprised in the training data and classifying the content elements comprised in the training data according to two or more privacy layers. Further, the detecting of the content elements may include isolating the content elements comprised in the training data. Further, the one or more machine learning models may be configured for detecting two or more content elements comprised in the one or more communication streams. Further, the one or more communication streams may not be included in the training data. Further, a first machine learning model of the one or more machine learning models may be configured for extracting at least one input feature from the one or more communication streams. Further, the at least one input feature may be provided to a second machine learning model of the one or more machine learning models. Further, the second machine learning model may be configured for generating at least one output based on the providing of the at least one input feature. Further, the one or more machine learning models may be configured for classifying the two or more content elements comprised in the one or more communication streams according to the two or more privacy layers. Further, the detecting of the two or more content elements comprised in the one or more communication streams and the classifying of the two or more content elements may be based on the at least one output. Further, the identifying of the one or more content elements comprised in the one or more communication streams includes selecting the one or more content elements from the two or more content elements comprised in the one or more communication streams according to the privacy layer based on the classifying of the two or more content elements, and the privacy layer. Further, the applying of the privacy layer on the one or more communication streams may be based on the selecting of the one or more content elements from the two or more content elements.

Further, in an embodiment, a third machine learning model of the one or more machine learning models may be configured for extracting one or more metadata from the one or more communication streams. Further, the first machine learning model of the one or more machine learning models may be configured for extracting at least one metadata input feature from the one or more communication streams. Further, the at least one metadata input feature may be provided to the second machine learning model of the one or more machine learning models. Further, the generating of the at least one output by the second machine learning model may be based on the providing of the at least one metadata input feature.

In some embodiments, the method 300 may further include receiving, using the communication device 502, an anonymization request data from the first user device. Further, the rule data includes the anonymization request data. Further, the manipulated data does not include any identification data associated with a first user corresponding to the first user device.

In some embodiments, the receiving of the first data may be performed through a first communication network. Further, the method 300 further includes receiving an indication of the first communication network from the first user device. Further, the rule data includes the indication of the first communication network. Further, the manipulated data does not include the first data.

In some embodiments, the method 300 may further include receiving, using the communication device 502, a modified rule data from the first user device. Further, the analysis of the first data may be further based on the modified rule data.

In some embodiments, the first data includes a video data corresponding to a face of a first user corresponding to the first user device. Further, the generating of the manipulated data includes blurring of the video data. Further, the rule data includes an indication of facial data as being sensitive.

In some embodiments, the first data includes an audio data corresponding to a voice of a first user corresponding to the first user device. Further, the generating of the manipulated data includes modifying the audio data. Further, the modifying results in non-identification of the first user based on the manipulated data. Further, the rule data includes an indication of the audio data as being sensitive.

In some embodiments, the rule data includes an indication of an application. Further, a part of the first data may be originated from the application. Further, the manipulated data does not include the part of the first data originated from the application. Examples of the application may include, but are not limited to, any application on a computer system, including Microsoft Office™, Adobe™, Google™ Suite, document creation, publishing platforms, and also applications for structured data and/or unstructured data.

In some embodiments, one or more of the analyzing of the first data and the generating of the manipulated data may be based on one or more artificial intelligence models.

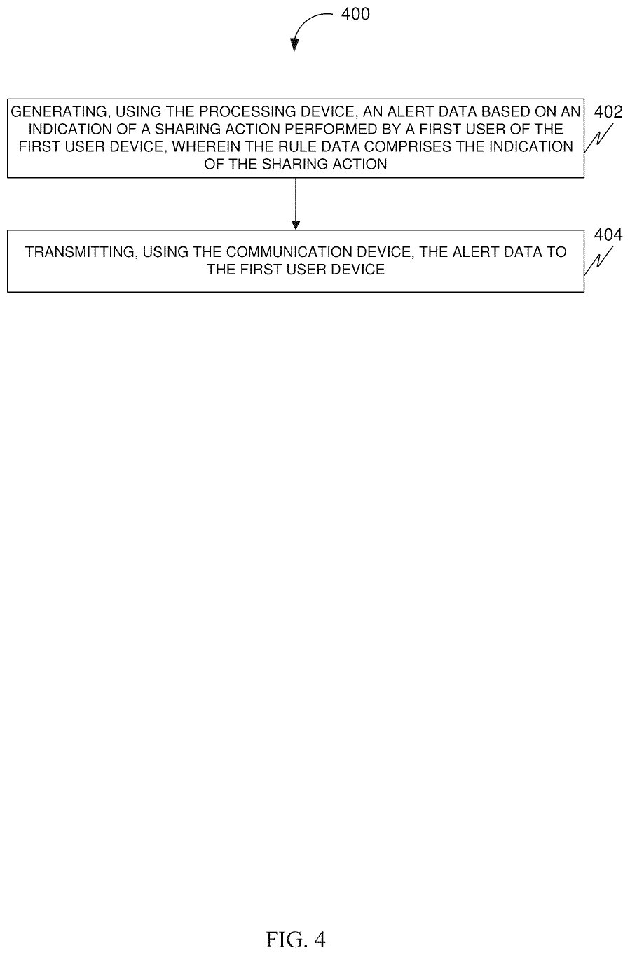

FIG. 4 illustrates a flowchart of a method 400 of facilitating secure communication including generating, using the processing device 504, an alert data, in accordance with some embodiments.

Further, in some embodiments, the method 400 further may include a step 402 of generating, using the processing device 504, an alert data based on an indication of a sharing action performed by a first user of the first user device. Further, the rule data includes the indication of the sharing action. Further, in some embodiments, the method 400 further may include a step 404 of transmitting, using the communication device 502, the alert data to the first user device.

In some embodiments, the generating of the manipulated data includes encrypting a part of the first data to obtain an encrypted data. Further, the manipulated data includes the encrypted data in place of the part of the first data.

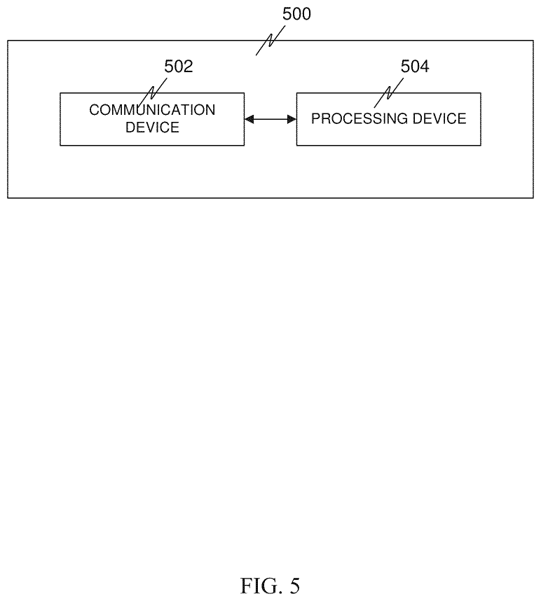

FIG. 5 illustrates a block diagram of a system 500 of facilitating secure communication, in accordance with some embodiments.

Accordingly, the system 500 may include a communication device 502. Further, the communication device 502 may be configured for receiving a first data from a first user device. Further, the communication device 502 may be configured for transmitting the first data to a second user device based on an analyzing. Further, the system 500 may include a processing device 504 which may be configured for analyzing the first data based on a rule data.

In some embodiments, the communication device 502 may be further configured for receiving anonymization request data from the first user device. Further, the rule data includes the anonymization request data. Further, the processing device 504 may be further configured for generating a manipulated data. Further, the manipulated data does not include any identification data associated with a first user corresponding to the first user device.

In some embodiments, the communication device 502 may be further configured for receiving a modified rule data from the first user device. Further, the analysis of the first data may be further based on the modified rule data.

In some embodiments, the first data includes a video data corresponding to a face of a first user corresponding to the first user device. Further, the processing device 504 may be further configured for generating a manipulated data comprising a blurred video data. Further, the rule data includes an indication of facial data as being sensitive.

In some embodiments, the first data includes an audio data corresponding to a voice of a first user corresponding to the first user device. Further, the processing device 504 may be further configured for generating a manipulated data comprising a modified audio data. Further, the modifying results in non-identification of the first user based on the manipulated data. Further, the rule data includes an indication of the audio data as being sensitive.

In some embodiments, the rule data includes an indication of an application. Further, a part of the first data may be originated from the application. Further, the processing device 504 may be further configured for generating a manipulated data. Further, the manipulated data does not include the part of the first data originated from the application.

In some embodiments, the processing device 504 may be further configured for generating a manipulated data based on the analyzing. Further, the generating of the manipulated data may be based on one or more artificial intelligence models.

In some embodiments, the processing device 504 may be further configured for generating a manipulated data. Further, the generating includes encrypting a part of the first data to obtain an encrypted data. Further, the manipulated data includes the encrypted data in place of the part of the first data.

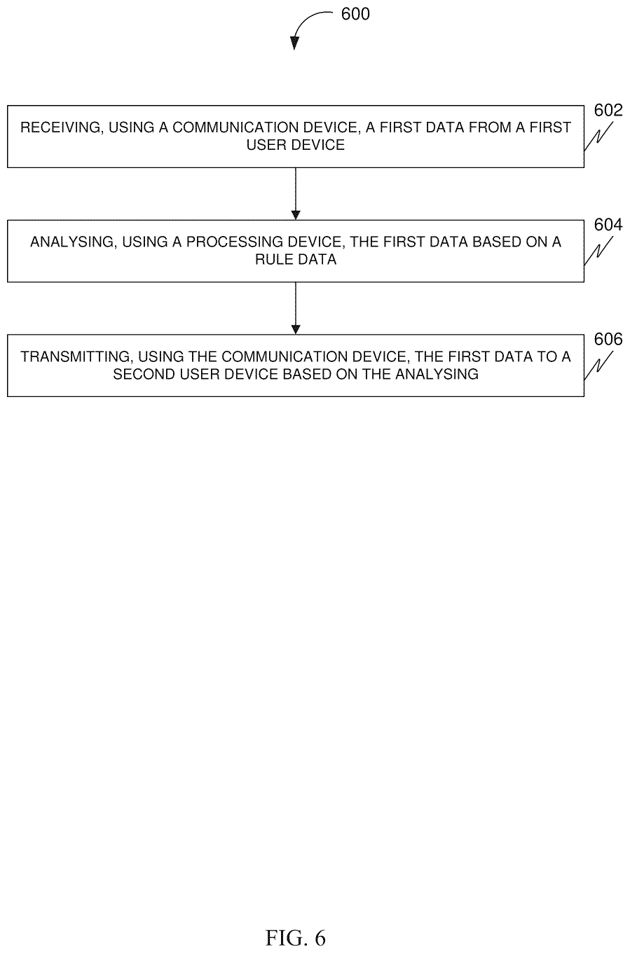

FIG. 6 illustrates a flowchart of a method 600 of facilitating secure communication, in accordance with some embodiments.

Accordingly, the method 600 may include a step 602 of receiving, using a communication device 502, a first data from a first user device. Further, the method 600 may include a step 604 of analyzing, using a processing device 504, the first data based on a rule data. Further, the method 600 may include a step 606 of transmitting, using the communication device 502, the first data to a second user device based on the analyzing.

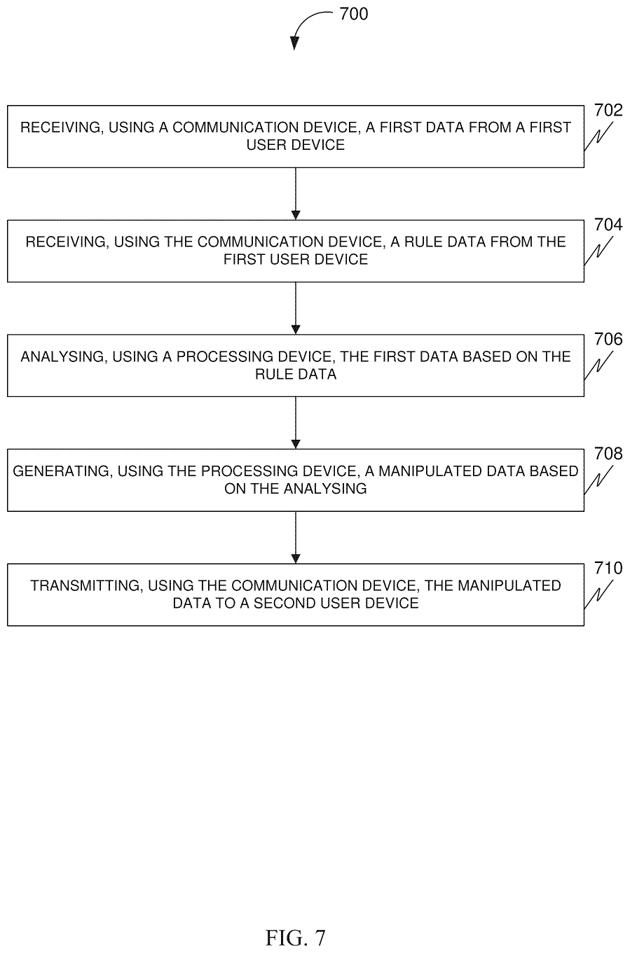

FIG. 7 illustrates a flowchart of a method 700 of facilitating secure communication, in accordance with some embodiments.

Accordingly, the method 700 may include a step 702 of receiving, using a communication device 502, a first data from a first user device. Further, the method 700 may include a step 704 of receiving, using the communication device 502, a rule data from the first user device. Further, the method 700 may include a step 706 of analyzing, using a processing device 504, the first data based on the rule data. Further, the method 700 may include a step 708 of generating, using the processing device 504, a manipulated data based on the analyzing. Further, the method 700 may include a step 710 of transmitting, using the communication device 502, the manipulated data to a second user device.

In some embodiments, the manipulated data does not include any identification data associated with a first user corresponding to the first user device.

In some embodiments, the method 300 may further include receiving, using the communication device 502, a subscription request from the first user device. Further, one or more of the analyzing, the generating and the transmitting may be based on the subscription request.

In some embodiments, the receiving of a part of the first data may be through a first communication network. Further, the rule data includes an indication of the first communication network. Further, the manipulated data does not include the part of the first data.

In some embodiments, the transmitting and the receiving of at least the first data and the second data, using a first communication network may be performed using one or more of a wired communication and a wireless communication.

In some embodiments, the method 300 may further include receiving, using the communication device 502, the rule data from one or more of the first user device and the second user device.

In some embodiments, the rule data includes a confidentiality parameter data.

In some embodiments, the method 300 may further include receiving, using the communication device 502, the confidentiality parameter data from one or more of the first user device and the second user device.

In some embodiments, the method 300 may be performed by an interaction platform.

In some embodiments, the first data corresponds to an online collaboration.

In some embodiments, the first data may be associated with one or more users.

In some embodiments, the first data includes a sensitive data whereas the manipulated data does not include the sensitive data.

In some embodiments, the sensitive data may be one or more of an image data, a video data, an audio data and a text data.

In some embodiments, the first data does not include identification data associated with a first user of the first user device.

In some embodiments, each of the first user device and the second user device may be one or more of a smartphone, a laptop computer, a tablet computer, a wearable computer and a desktop computer.

In some embodiments, each of the first user device and the second user device operates based on one or more of an android operating system and an iPhone Operating System.

In some embodiments, the communication device 502 may be an electronic device which may be configured to one or more of transmit and receive a data.

In some embodiments, the first user device includes a first processing device which may be configured for executing a first conferencing application. Further, the second user device includes a second processing device which may be configured for executing a second conferencing application.

In some embodiments, each of the first conferencing application and the second conferencing application includes one or more of a video conferencing application, an audio-conferencing application, an image sharing application and a text sharing application.

In some embodiments, the first conferencing application may be dissimilar to the second conferencing application.

In some embodiments, the first data corresponds to an online conference between a first user associated with the first user device and a second user associated with the second user device.

In some embodiments, one or more of the first data and the manipulated data may be a digital stream.

In some embodiments, the rule data includes an indication of an application. Further, a part of the first data may be originated from the application.

In some embodiments, the rule data includes an indication of an application. Further, the first data may be originated from the application. Further, the manipulated data does not include the first data.

In some embodiments, the rule data includes an indication of a first local network. Further, the receiving of the first data may be performed through the first local network. Further, the method 300 further includes receiving an indication of the first local network from the first user device. Further, the manipulated data does not include the first data.

In some embodiments, the rule data includes an indication of concealing of a part of the first data. Further, a concealing request may be received from one or more of the first user device and the second user device.

In some embodiments, the application may be one or more of a social media application and a financial application.

In some embodiments, the generating includes redacting a sensitive data of the first data. Further, the manipulated data does not include the sensitive data.

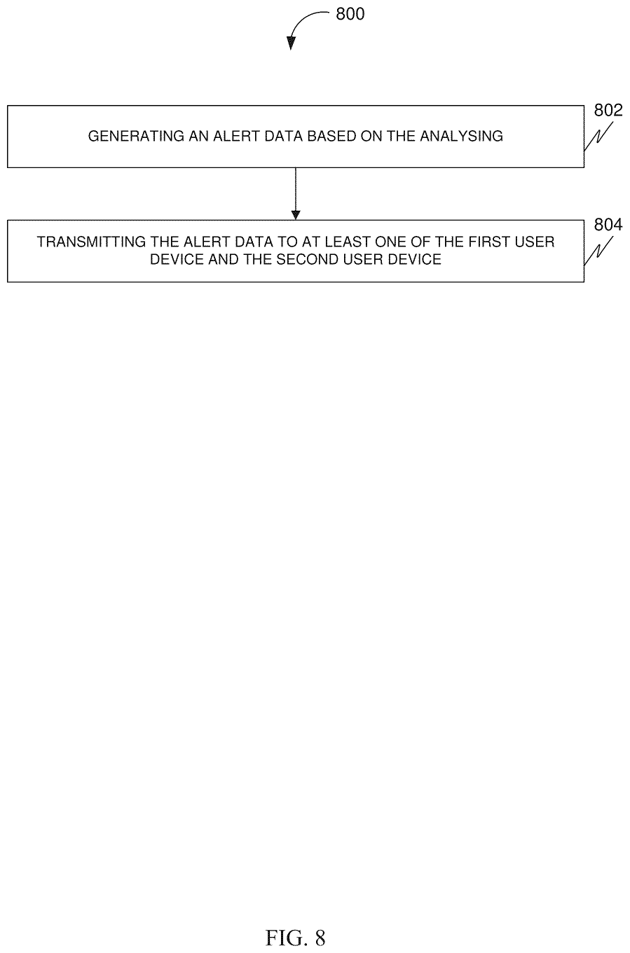

FIG. 8 illustrates a flowchart of a method 800 of facilitating secure communication including generating an alert data, in accordance with some embodiments.

Further, in some embodiments, the method 800 further may include a step 802 of generating an alert data based on the analyzing. Further, in some embodiments, the method 800 further may include a step 804 of transmitting the alert data to one or more of the first user device and the second user device.

In some embodiments, the encrypting may be based on one or more confidentiality parameters.

In some embodiments, the method 300 may further include storing, using a storage device, one or more of the first data and the manipulated data based on a storage criterion.

In some embodiments, the storage criterion includes a criterion corresponding to accessibility of one or more of the first data and the manipulated data by one or more of the first user device and the second user device.

The present disclosure provides a method of facilitating secure communication. Further, the method may include capturing, using a processing device, a first data presented on a first user device through one or more presentation devices. The first data may be originated from an application such as, but are not limited to, any application on a computer system, including a collaboration application and/or a communication application. For example, the application may include a video conferencing application such as Zoom™, Teams™, Google Meet™ and so on. Other examples of the application may include, but are not limited to, any application on a computer system, including Microsoft Office™, Adobe™, Google™ Suite, document creation, publishing platforms, and also applications for structured data and/or unstructured data.

Further, the method may include analyzing, using the processing device, the first data based on a rule data. Further, the method may include generating, using the processing device, a manipulated data based on the analyzing. The method may further include screen capturing of the video conference without being associated with the video conferencing application. The method may further include generation of a manipulated data based on the process of Optical Character Recognition which helps in detecting sensitive data which may include, phone number, Social Security Number, emails, credit card statements and system credentials. In some embodiments, the method may further include storing the manipulated data in a region of memory, such as network buffer, associated with a video conferencing application. Further, the method may include transmitting, using a communication device, the manipulated data to a second user device.

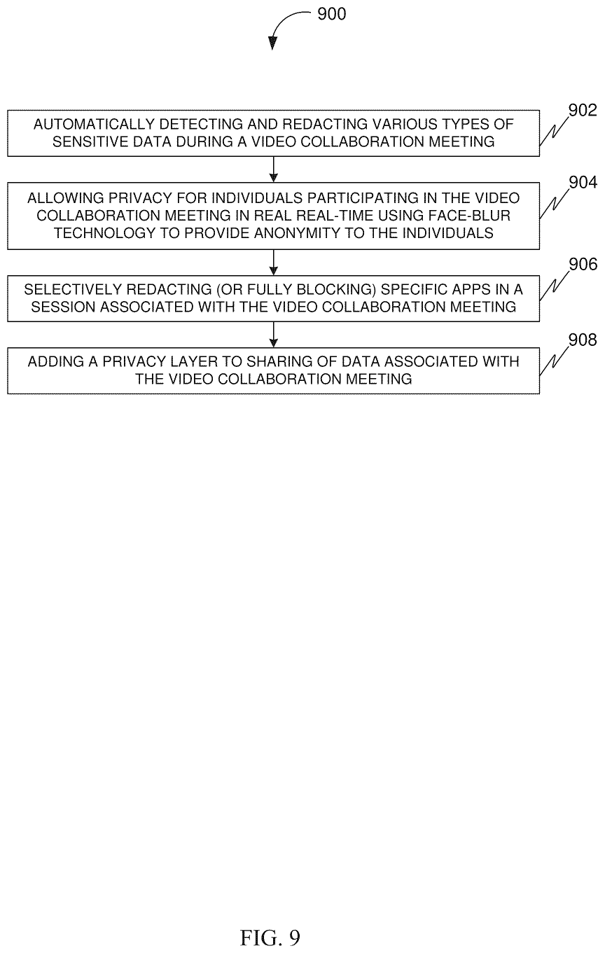

FIG. 9 is a flowchart of a method 900 for facilitating data security during online information stream collaboration, in accordance with some embodiments.

Further, the method 900 may include a step 902 of automatically detecting and redacting various types of sensitive data during an information stream collaboration meeting. Further, the information stream collaboration meeting may include, but may not be limited to, a video collaboration meeting.

Further, the method 900 may include a step 904 of allowing privacy for individuals participating in the information stream collaboration meeting in real-time using an anonymization technology to provide anonymity to the individuals. Further, the anonymization technology may include face-blur technology.

Further, the method 900 may include a step 906 of selectively redacting (or fully blocking) specific apps in a session associated with the information stream collaboration meeting.

Further, the method 900 may include a step 908 of adding a privacy layer to sharing of data associated with the information stream collaboration meeting. Further, in some embodiments, the method may include a step of generating an alert based on detecting of the sharing of the data.

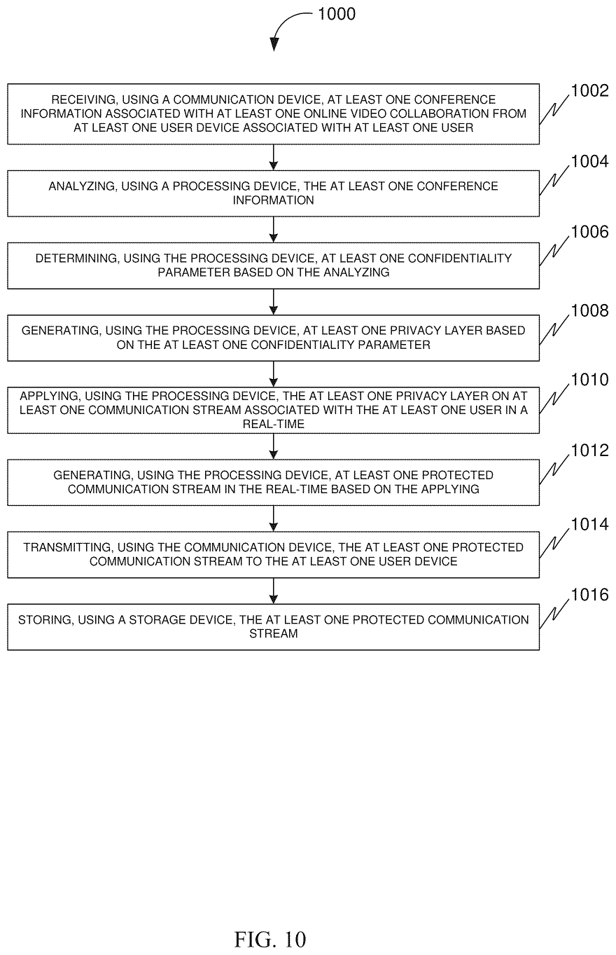

FIG. 10 is a flowchart of a method 1000 for facilitating data security during online information stream collaboration, in accordance with some embodiments.

Further, the method 1000 may include a step 1002 of receiving, using a communication device 502, at least one conference information associated with at least one online information stream collaboration from at least one user device associated with at least one user. Further, the at least one user may be participating in the at least one online information stream collaboration. Further, the at least one user device may include, but may not be limited to, a smartphone, a laptop, a desktop, a tablet computer, etc.

Further, the method 1000 may include a step 1004 of analyzing, using a processing device 504, the at least one conference information.

Further, the method 1000 may include a step 1006 of determining, using the processing device 504, at least one confidentiality parameter based on the analyzing. Further, in some embodiments, the at least one confidentiality parameter may be based on at least one user input based on at least one input action by the at least one user using the at least one user device. Further, the at least one user input may indicate a user-specific anonymization request.

Further, the method 1000 may include a step 1008 of generating, using the processing device 504, at least one privacy layer based on the at least one confidentiality parameter.

Further, the method 1000 may include a step 1010 of applying, using the processing device 504, the at least one privacy layer on at least one communication stream associated with the at least one user in a real-time. Further, the at least one communication stream may include, but may not be limited to, a video stream, an audio stream, a text stream, etc.

Further, the method 1000 may include a step 1012 of generating, using the processing device 504, at least one protected communication stream in the real-time based on the applying.

Further, the method 1000 may include a step 1014 of transmitting, using the communication device 502, the at least one protected communication stream to the at least one user device.

Further, the method 1000 may include a step 1016 of storing, using a storage device 1104, the at least one protected communication stream.

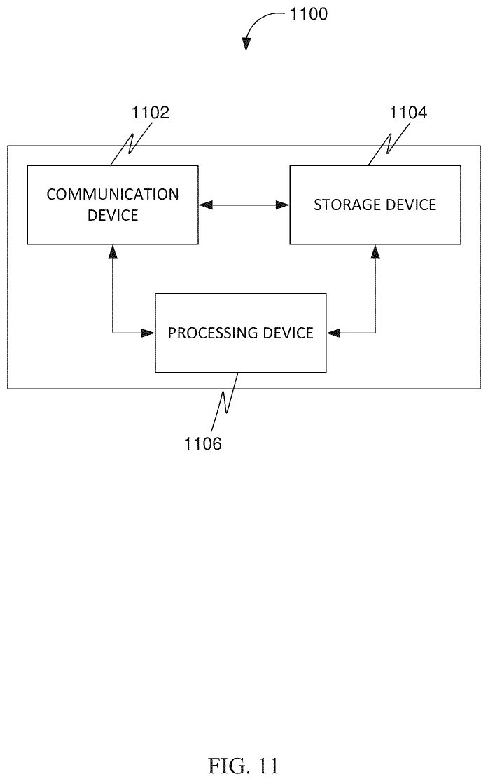

FIG. 11 is a block diagram of a system 1100 for facilitating data security during online information stream collaboration, in accordance with some embodiments. Accordingly, the system 1100 may include a processing device 1106, a communication device 1102, and a storage device 1104. Further, the communication device 1102 may be communicatively coupled with the processing device 1106. Further, the communication device 1102 may be communicatively coupled with the storage device 1104. Further, the storage device 1104 may be communicatively coupled with the processing device 1106. Further, the communication device 1102 may be configured for receiving at least one conference information associated with at least one online information stream collaboration from at least one user device associated with at least one user. Further, the at least one user may be participating in the at least one online information stream collaboration. Further, the at least one user device may include, but may not be limited to, a smartphone, a laptop, a desktop, a tablet computer, etc. Further, the communication device 1102 may be configured for transmitting at least one protected communication stream to the at least one user device.

Further, the processing device 1106 may be configured for analyzing the at least one conference information. Further, the processing device 1106 may be configured for determining at least one confidentiality parameter based on the analyzing. Further, the processing device 1106 may be configured for generating at least one privacy layer based on the at least one confidentiality parameter. Further, the processing device 1106 may be configured for applying the at least one privacy layer on at least one communication stream associated with the at least one user in a real-time. Further, the at least one communication stream may include, but may not be limited to, a video stream, an audio stream, a text stream, etc. Further, the processing device 1106 may be configured for generating the at least one protected communication stream in the real-time based on the applying. Further, in some embodiments, the at least one confidentiality parameter may be based on at least one user input based on at least one input action by the at least one user using the at least one user device. Further, the at least one user input may indicate a user-specific anonymization request.

Further, the storage device 1104 may be configured for storing the at least one protected communication stream.

Although the invention has been explained in relation to its preferred embodiment, it is to be understood that many other possible modifications and variations can be made without departing from the spirit and scope of the invention as hereinafter claimed.

What is claimed is:

1. A method of facilitating secure communication, the method comprising:
receiving, using a communication device, a first data from a first user device;
analyzing, using a processing device, the first data based on a rule data;
generating, using the processing device, a manipulated data based on the analyzing; and
transmitting, using the communication device, the manipulated data to a second user device.

2. The method of claim 1, further comprising receiving, using the communication device, an anonymization request data from the first user device, wherein the rule data comprises the anonymization request data, wherein the manipulated data does not comprise any identification data associated with a first user corresponding to the first user device.

3. The method of claim 1, wherein the receiving of the first data is performed through a first communication network, wherein the method further comprises receiving an indication of the first communication network from the first user device, wherein the rule data comprises the indication of the first communication network, wherein the manipulated data does not comprise the first data.

4. The method of claim 1 further comprising receiving, using the communication device, a modified rule data from the first user device, wherein the analysis of the first data is further based on the modified rule data.

5. The method of claim 1, wherein the first data comprises a video data corresponding to a face of a first user corresponding to the first user device, wherein the generating of the manipulated data comprises blurring of the video data, wherein the rule data comprises an indication of facial data as being sensitive.

6. The method of claim 1, wherein the first data comprises an audio data corresponding to a voice of a first user corresponding to the first user device, wherein the generating of the manipulated data comprises modifying the audio data, wherein the modifying results in non-identification of the first user based on the manipulated data, wherein the rule data comprises an indication of the audio data as being sensitive.

7. The method of claim 1, wherein the rule data comprises an indication of an application, wherein a part of the first data is originated from the application, wherein the manipulated data does not comprise the part of the first data originated from the application.

8. The method of claim 1 wherein, at least one of the analyzing of the first data and the generating of the manipulated data is based on at least one artificial intelligence model.

9. The method of claim 1 further comprises:
generating, using the processing device, an alert data based on an indication of a sharing action performed by a first user of the first user device, wherein the rule data comprises the indication of the sharing action; and
transmitting, using the communication device, the alert data to the first user device.

10. The method of claim 1, wherein the generating of the manipulated data comprises encrypting a part of the first data to obtain an encrypted data, wherein the manipulated data comprises the encrypted data in place of the part of the first data.

11. A system for facilitating secure communication, the system comprising:
a communication device configured for:
receiving a first data from a first user device; and
transmitting the first data to a second user device based on an analyzing; and
a processing device configured for analyzing the first data based on a rule data.

12. The system of claim 11, wherein the communication device is further configured for receiving anonymization request data from the first user device, wherein the rule data comprises the anonymization request data, wherein the processing device is further configured for generating a manipulated data, wherein the manipulated data does not comprise any identification data associated with a first user corresponding to the first user device.

13. The system of claim 11, wherein the communication device is further configured for receiving a modified rule data from the first user device, wherein the analysis of the first data is further based on the modified rule data.

14. The system of claim 11, wherein the first data comprises a video data corresponding to a face of a first user corresponding to the first user device, wherein the processing device is further configured for generating a manipulated data comprising a blurred video data, wherein the rule data comprises an indication of facial data as being sensitive.

15. The system of claim 11, wherein the first data comprises an audio data corresponding to a voice of a first user corresponding to the first user device, wherein the processing device is further configured for generating a manipulated data comprising a modified audio data, wherein the modifying results in non-identification of the first user based on the manipulated data, wherein the rule data comprises an indication of the audio data as being sensitive.

16. The system of claim 11, wherein the rule data comprises an indication of an application, wherein a part of the first data is originated from the application, wherein the processing device is further configured for generating a manipulated data, wherein the manipulated data does not comprise the part of the first data originated from the application.

17. The system of claim 11 wherein the processing device is further configured for generating a manipulated data based on the analyzing, wherein the generating of the manipulated data is based on at least one artificial intelligence model.

18. The system of claim 11, wherein the processing device is further configured for generating a manipulated data, wherein the generating comprises encrypting a part of the first data to obtain an encrypted data, wherein the manipulated data comprises the encrypted data in place of the part of the first data.

19. A method of facilitating secure communication, the method comprising:
receiving, using a communication device, a first data from a first user device;
analyzing, using a processing device, the first data based on a rule data; and
transmitting, using the communication device, the first data to a second user device based on the analyzing.

20. A method of facilitating secure communication, the method comprising:
receiving, using a communication device, a first data from a first user device;
receiving, using the communication device, a rule data from the first user device;
analyzing, using a processing device, the first data based on the rule data;
generating, using the processing device, a manipulated data based on the analyzing; and
transmitting, using the communication device, the manipulated data to a second user device.
